(19) United States
(12) Patent Application Publication
(10) Pub. No.: US 2009/0231970 A1
(43) Pub. Date: Sep. 17, 2009

(54) Method, device and record carrier for providing media-related parameters

(75) Inventor: Franciscus Johannes Robertus Verhallen, Eindhoven (NL)

Correspondence Address: WPAT, PC, 7225 BEVERLY ST., ANNANDALE, VA, 22003, US

(73) Assignee: LITE-ON IT CORPORATION, Taipei City (TW)

(21) Appl. No.: 12/401,818

(22) Filed: Mar. 11, 2009

Related U.S. Application Data
(60) Provisional application No. 61/069,296, filed on Mar. 12, 2008.

(51) Int. Cl. G11B 20/00

(52) U.S. Cl. 369/47.15; G9B/20

(57) ABSTRACT

The method is used for determining the value of a recording parameter for writing user information on an information layer of an optical record carrier using a recording device. The method comprises the steps of:
reading control information from the record carrier relating to a selected write strategy for recording at a specified nominal recording speed on the information layer;
selecting a set of parameter values from different sets of parameter values provided in the control information for said write strategy, said recording speed and said information layer; and
taking a value of the recording parameter provided in the selected set of parameter values for recording user information on the optical record carrier.

### FIELD OF THE INVENTION

The invention relates to a method of determining the value of a recording parameter for writing user information, an optical record carrier comprising sets of parameter values and an recording device for writing user information using said value of the recording parameter.

### BACKGROUND OF THE INVENTION

Known optical recording devices write user information on an optical record carrier by making optically detectable marks in an information layer of the record carrier. The length of the marks and the length of the areas between marks represent the user information. The recording device writes the marks by controlling the power in a radiation spot formed on tracks in the information layer. A mark may be written by one or more pulses of radiation power, depending on the length of the mark. The shape of the pulses may also depend on the length of the mark to be written. The overall shape of the pulses used for writing the marks is determined by a so-called write strategy. The actual values of recording parameters, such as power level and timing of the pulses, depend, amongst others, on the specific information layer and the specific recording speed. The actual values are usually determined experimentally by the manufacturer of the record carrier and/or by the recording device by performing a so-called calibration run. Each write strategy may have several sets of parameter values for different information layers and different recording speeds.

The manufacturer of a recordable record carrier usually records a recommended write strategy and a set of recommended parameter values in a block of control information in the information layer. The recording device can read these parameter values and use them to set the power levels and timing of the pulses for writing the marks in the information layer.

According to standards for optical recording, a record carrier may comprise information for several write strategies, allowing a recording device to choose a strategy that is most suitable for the device. For each write strategy and each recording speed a single set of parameter values is recorded on the record carrier. Where the record carrier is a multi-layer record carrier, a set of parameters for each write strategy and each recording speed may be provided for each information layer.

When improved recording devices become available, the sets of parameter values stored on record carriers and made for previous recording devices need not provide the highest quality recording that can be attained with the improved recording devices.

It is an object of the invention to improve the quality of recording when improved recording devices become available and at the same time maintain backward compatibility with previous recording devices.

### SUMMARY OF THE INVENTION

The object of the invention is achieved by a method for determining the value of a recording parameter for writing user information on an information layer of an optical record carrier using a recording device, the method comprising the steps of:

reading control information from the record carrier relating to a selected write strategy for recording at a specified nominal recording speed on the information layer;

selecting a set of parameter values from a plurality of different sets of parameter values provided in the control information for said write strategy, said recording speed and said information layer; and

taking a value of the recording parameter provided in the selected set of parameter values for recording the user information on the optical record carrier.

The invention permits the recording of a plurality of different sets of parameter values for a specific write strategy, a specific nominal recording speed and a specific information layer. The recording device must be able to select a set of parameter values out of the provided plurality of sets. Backward compatibility is guaranteed, because a record carrier comprising a set of parameter values for a new recording device can also comprise a set for previous recording devices, thereby allowing a previous recording device to record data, albeit not with the highest quality.

In a multi-layer record carrier a plurality of different sets of parameter values may be provided, applicable to all information layers, or a plurality of different sets of parameter values are provided for each of the information layers, the corresponding sets between information layers being different.

In an advantageous embodiment of the method, the set of parameter values is selected from a group of sets of parameter values that are compatible with the recording device.

A recording device can select a group of sets of parameter values that matches the capabilities of the recording device. This group may contain one set or several sets. When the group contains several sets, the recording device can make a choice within the group.

In a more advantageous embodiment of the method where the sets of parameter values provide recordings on the record carrier having different levels of quality, the selected set of parameter values provides the highest level of quality of recording on the record carrier.

Since a new recording device is usually able to use sets of parameter values designed for previous recording devices, the group of sets compatible with the new recording device will include the sets for the previous devices. These sets do not provide recordings of equally high quality as the set for the new recording device. Therefore, the recording device should preferably select that set from the group of compatible sets that provides the highest quality recording.

To facilitate the determination of whether a set of parameter values is compatible with a recording device, each of the sets of parameter values advantageously comprises a value of a compatibility parameter for determining compatibility between the set of parameter values and the recording device.

The embodiment makes it unnecessary to compare a relatively long list of parameter values and the capabilities of recording device. A mere comparison of the value of the compatibility parameter recorded in the set of parameter values on the record carrier and the corresponding value stored in the recording device permits determination whether the set is compatible with the recording device or not. The compatibility parameter can be a minimum pulse width the recording device must be able to produce when using the write strategy with this set of parameter values.

Where the sets of parameter values provide recordings on the record carrier having different levels of quality, the determination of the set of parameter values providing the highest level of recording quality may be facilitated if the sets of parameter values are recorded on the record carrier in order of descending level of quality, and the sets of parameter values are read in order of descending level of quality. The first set compatible with the recording device will also be the set providing the highest quality recording.

A further aspect of the invention relates to an optical record carrier for recording user information on an information layer, comprising a block of control information, the control information comprising information units, a plurality of the information units pertaining to one write strategy for recording at a specified nominal recording speed on the information layer, and each of the plurality of information units comprising a different set of parameter values of one or more parameters pertaining to the write strategy.

Advantageously, each set of parameter values comprises a value of a compatibility parameter for determining compatibility between the set of parameter values and a recording device for recording user information on the information layer.

Advantageously, the information units are arranged in the record carrier in the order of descending level of recording quality.

A still further aspect of the invention relates to an optical recording device comprising a write unit for recording user information on an information layer of an optical record carrier, a read unit for reading information from the record carrier, and a control unit, the operation of the write unit depending on the value of a recording parameter, wherein the control unit is arranged to control the read unit for reading control information from the record carrier relating to a selected write strategy for recording at a specified nominal recording speed on the information layer, to select a set of parameter values from a plurality of different sets of parameter values provided in the control information for said write strategy, said recording speed and said information layer; and taking a value of the recording parameter provided in the selected set of parameter values.

The recording device interrelates with the record carrier according to the invention in that it retrieves information from the plurality of sets of parameter values according to the invention provided on the record carrier.

In an advantageous embodiment of the recording device the control unit is arranged for selecting a set of parameter values compatible with the recording device.

Where the set of parameter values provide recordings on the record carrier having different levels of quality, the control unit is advantageously arranged for selecting the set of parameter values that provides the highest level of quality of recording on the record carrier.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a schematic diagram of an optical recording device;

FIG. 2 shows a write pulse waveform;

FIG. 3A shows the layout of the block of control information on the record carrier;

FIG. 3B shows the layout of a unit of control information.

### DETAILED DESCRIPTION OF THE INVENTION

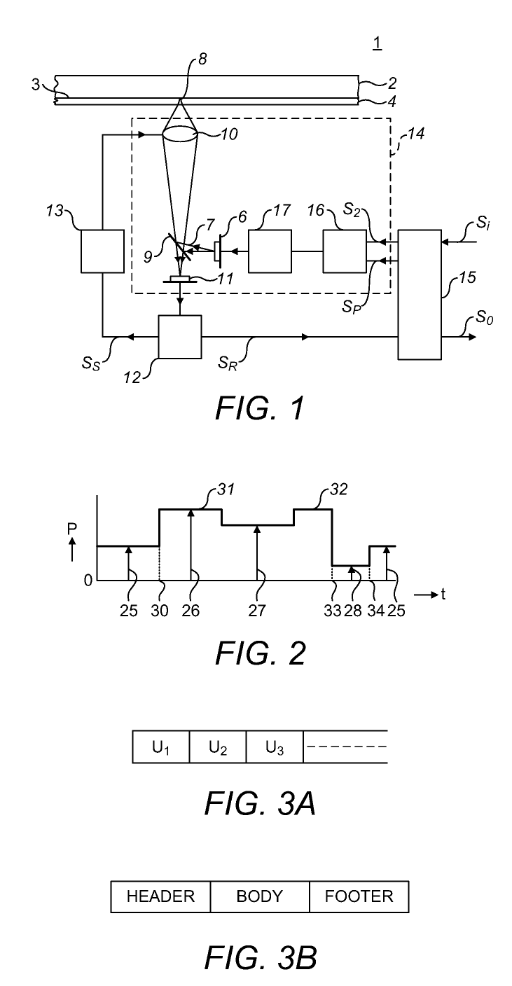

FIG. 1 shows an optical recording device and an optical record carrier according to the invention. Record carrier 1 has a substrate layer 2, a recording layer or information layer 3 arranged on it and a transparent cover layer 4 protecting the information layer. The recording layer comprises a material suitable for writing information by means of a radiation beam. The recording layer may be of e.g. the magneto optical type, the phase-change type, the dye type or of any other suitable material. The invention is applicable to any of these media. Information may be recorded in the form of optically detectable regions, also called marks, on the information layer 3.

The recording device comprises a radiation source 6, e.g. a semiconductor laser, for emitting a radiation beam 7. The radiation beam is converged to a focus 8 on the recording layer 3 via a beam splitter 9, an objective lens 10 and the cover layer 4. The record carrier may also be air-incident, where the radiation beam is incident directly on recording layer 3 without passing through a cover layer. Radiation reflected from medium 1 is converged by the objective lens 10 and, after passing through the beam splitter 9, falls on a detection system 11, which converts the incident radiation in electric detector signals.

The detector signals are input to a circuit 12. The circuit derives several signals from the detector signals, such as a read signal S_{R} representing the information being read from record carrier 1. The radiation source 6, beam splitter 9, objective lens 10, detection system 11 and circuit 13 together form a read unit. In an alternative embodiment beam splitter 9 is a diffraction grating, and detection system 11 is arranged close to radiation source 6.

The circuit 12 also derives servo signals Ss from the detector signals. The servo signals may comprise a radial error signal and a focus error signal, representing a distance between the focus 8 and the information layer 3 in a transverse direction and a longitudinal direction, respectively. The servo signals are processed in a servo circuit 13, output signals of which control the transverse and longitudinal position of the objective lens 10, schematically indicated in the figure by the line connecting elements 13 and 10. Another output signal controls the position of the optical pickup unit 14 with respect to the record carrier 1. The optical pick-up unit includes the elements 6, 7, 9, 10 and 11.

The read signal S_{R} from circuit 12 is supplied to a control unit 15, e.g. a micro-processor. Circuit 12 and control unit 15 may be circuits suitable for processing analog signals or circuits suitable for processing digital signals. The control unit 15 processes the read signal, e.g. by decoding and error-correction processing, to form an information output signal Sₒ representing the information read from record carrier 1.

The control unit 15 may determine a parameter representing the quality of the read signal S_{R}. The parameter may be the amplitude of the read signal, such as modulation or a combination of the modulation of high- and low-frequency components in the read signal. The parameter may also relate to the timing of transitions in the read signal, such as jitter. The control unit 11 may comprise means for deriving more than one parameter from the read signal S_{R}.

User information Sᵢ to be recorded on the record carrier 1 is input to the control unit 15. The control unit adds error-correction information to the user information and encodes the resulting information to an information signal S₂. The information signal S₂ is output to a write strategy generator 16 that converts the information signal into a series of pulses fed into a driver 17. The driver 17 controls the output power of the radiation source 6. The driver 17, radiation source 6, beam splitter 9 and objective lens 10 together form a write unit.

The radiation pulses emitted by radiation source 6 induce marks in the form of optically detectable changes in recording layer 3. Such a mark may be written by a single radiation pulse. A mark may also be written by a series of radiation pulses of equal or different lengths.

The actual radiation power emitted by radiation source 6 may be measured by a not-shown power detector arranged in an otherwise not-used side lobe of the radiation beam or in radiation reflected off a component in the optical path of the radiation beam. The signal of the power detector may be connected directly to control unit 15.

The information signal S₂ represents the information in a pattern of ‘1’s and ‘0’s. The information signal may be coded such that only series of 2 to 9 ‘1’s occur in the pattern. The length of the series is expressed as 2T to 9T, where T is the duration of a channel bit. T is 15.1 ns for a Blu-ray Disc at reference recording speed, also referred to as 1× speed and equivalent to about 3.49 m/s. Each series of ‘1’s is written as a mark on the information layer, the length of which represents the number of ‘1’s in the series and each series of ‘0’s as an unwritten area between marks, the length of which corresponds to the number of ‘0’s, or vice versa. The write strategy generator 16 converts each series of ‘1’s into a one or more radiation pulses. Usually the shape of the pulses for 2T and 3T deviates from the shape of the pulses 4T to 9T. The write strategy determines the overall shape of the pulses for each series occurring in the information signal S₂. Common write strategies for high-density recording, such as Blu-ray, are the so-called N−1 write strategy, N/2 write strategy and castle write strategy, in order of increasing suitability for higher recording speeds

The actual shape of the radiation pulses is determined by a series of parameter values. FIG. 2 shows as an example some parameters for the 5T pulse of the castle strategy. The figure shows the power P of the pulse as function of time t. The values of the following parameters are necessary to define the pulse: a space power 25, a write peak power 26, a middle power 27, a cooling power 28, a start time 30 of the top level, a top level duration 31, a last pulse duration 32, a cooling level start time 33 and a start time of the space level 34.

The values of the start time parameters and the duration parameters are normally stored in the sets of parameter values on the record carrier. The values of the power parameters are usually not stored in the sets. Instead, a series of parameters values necessary for a so-called optical power calibration procedure is recorded in the sets. During the optical power calibration a plurality of patterns of marks is written in the information layer. The dependence of the modulation of the read signals obtained from these marks and the parameters stored in the sets allow the determination of the values of the power parameters. The procedure of the optical power calibration is normally defined in a standard for the optical record carrier.

The type of write strategy and the parameter values to be applied for an information layer to be recorded are read by the read unit from the record carrier 1 and transmitted in the signal S_{R} to the control unit. The control unit sends the type and values as a signal Sₚ to the write strategy generator 16. The write strategy and the parameter values are provided for a specified nominal recording speed on the information layer, but they also apply to recording speeds in a range around the nominal speed. The upper and lower limit of the range may be included in the control information recorded in the record carrier. The range allows the information layer to be recorded in the so-called modified constant linear velocity (MCLV) or the modified constant angular velocity (MCAV) modes.

The control information relating to type of write strategy and values of parameters applicable for recording on the information layer 3 are stored in the record carrier 1, either on the same information layer to be recorded or on another information layer of the record carrier. In the latter case the control information for all information layers and all recording speeds for a multi-layer record carrier may be stored in a single block of information in one of the information layers of the record carrier. The single block of information may also be repeated on all information layers of the record carrier.

The control information stored on the record carrier may be arranged in units, each unit providing information for recording an information layer at a specific speed. FIG. 3A shows the layout of a block of disc information on the record carrier. The disc information includes the control information. The figure shows a first unit of disc information U1, a second unit U2, and a third unit U3. Each unit Un has a layout as shown in FIG. 3B. A header of a unit comprises information about the layout of the unit, such as a sequence number and format of the unit. A footer comprises information about the disc manufacturer, media type and production and revision data. A body of each unit comprises general disc parameters, read/write power values and write strategy parameter values. The general disc parameters may include identification of the information layer in a multi-layer record carrier, structure of information in the information layer, polarity of signals read from the information layer, and position of the information zone.

Table I shows a first example of a series of units Un on an information layer.

TABLE I
Control information for single layer record carrier

| U | layer | speed | write strategy | pulse width | set |
|---|---|---|---|---|---|
| 1 | 0 | 1× | N − 1 | 2.0 ns | 1 |
| 2 | 0 | 2× | N/2 | 2.0 ns | 2 |
| 3 | 0 | 4× | Castle | 2.0 ns | 3 |
| 4 | 0 | 6× | Castle | 1.5 ns | 4 |
| 5 | 0 | 6× | Castle | 2.0 ns | 5 |

Each of the units 1 to 5 in Table I includes a set of parameter values. The control information includes two different sets of parameter values, set 4 and set 5, for a single write strategy, the castle strategy, at a single nominal recording speed of 6× the reference speed. The two sets are characterised by different minimum pulse width as compatibility parameter. At higher recording speed a shorter minimum pulse width is required for optimum recording quality. Set 4 provides the parameter values for this optimum recording quality. For backward compatibility a set 5 of parameter values is provided pertaining to a longer minimum pulse width. However, the level of quality of recording using set 5 is lower than using set 4.

The pulse width is the minimum width occurring in the patterns of radiation pulses. In the waveform of the castle strategy shown in FIG. 2 the minimum width corresponds to the shortest duration of top level duration 31, top level duration 32, or any other period of constant power in this pulse shape. A recording device can use the set of parameter values if it is compatible with the pulse width requirement: if it can generate a minimum pulse width of 1.5 ns or 2.0 ns.

A recording device of a new generation will be able to produce pulses as short as 1.5 ns and will therefore record information at 6× speed using set 4 of parameter values. In such a recording device the write strategy generator 16, as shown in FIG. 1, may be mounted on the optical pick-up unit 14, to reduce the length of the transmission lines to the driver 17, thereby increasing the bandwidth for transmission.

In previous generation or cheaper recording devices the write strategy generator 16 may be integrated with the control unit 15, which is mounted on the frame of the recording device. The high-frequency output signals for the driver 17 must then be transmitted to the driver 17 on the optical pick-up unit 14 by a flexible electrical connection, which has a limited bandwidth. Such a recording device might only be able to produce a minimum pulse width of 2.0 ns. When recording at 6× speed using the castle strategy, the recording device must use set 5 of parameter values.

To avoid too large a deterioration of the quality of recording when using the sub-optimal set 5, the previous generation recording device should preferably to some extent compensate the loss in quality by more stringent requirements on parameters such as defocus, radial position of the spot, spherical aberration correction, tilt correction, and adjustment of write power. An optical record standard may limit the deterioration of the quality of the recording when using set 5 instead of set 4. The limitation may be expressed as a maximum increase of jitter, for example an increase of 1% using set 5 where jitter using set 4 is limited to 7%. A read device must have sufficient margins to cope with the additional jitter of the read signal when it reads a record carrier recorded by using set 5.

Table II shows a second example of a series of units Un on an information layer.

TABLE II
Control information for single layer record carrier

| U | layer | speed | write strategy | pulse width | set |
|---|---|---|---|---|---|
| 1 | 0 | 1× | N − 1 | 2.0 ns | 1 |
| 2 | 0 | 2× | N/2 | 2.0 ns | 2 |
| 3 | 0 | 4× | Castle | 2.0 ns | 3 |
| 4 | 0 | 6× | Castle | 1.3 ns | 4 |
| 5 | 0 | 6× | Castle | 1.6 ns | 5 |
| 6 | 0 | 6× | Castle | 2.0 ns | 6 |

The control information in Table II provides three different sets of parameter values, set 4, set 5 and set 6, for three different values of the compatibility parameter pulse width. It allows recording devices having different capabilities to select a parameter set close to the capabilities of the recording device, thereby achieving a higher level of quality recording.

For a recording device having a minimum pulse width of 1.6 ns, a group of parameter sets 5 and 6 will be compatible. Since a shorter minimum pulse width results in a better quality recording, the recording device preferably chooses set 5.

Table III shows a third example of a series of units Un on a dual layer record carrier.

TABLE III
Control information for dual layer record carrier

| U | layer | speed | write strategy | pulse width | set |
|---|---|---|---|---|---|
| 1 | 0 | 1× | N − 1 | 2.0 ns | 1 |
| 2 | 1 | 1× | N − 1 | 2.0 ns | 2 |
| 3 | 0 | 2× | N − 1 | 2.0 ns | 3 |
| 4 | 1 | 2× | N/2 | 2.0 ns | 4 |
| 5 | 0 | 4× | Castle | 2.0 ns | 5 |
| 6 | 1 | 4× | Castle | 2.0 ns | 6 |
| 7 | 0 | 6× | Castle | 1.5 ns | 7 |
| 8 | 1 | 6× | Castle | 1.5 ns | 8 |
| 9 | 0 | 6× | Castle | 2.0 ns | 9 |
| 10 | 1 | 6× | Castle | 2.0 ns | 10 |

The control information in Table III is similar to that in Table I, but it includes different sets of parameter values for both information layer 0 and information layer 1.

On initialisation of a recording session, a recording device will start reading control information such as presented in Table III from the record carrier. If the recording device can write at 6× speed using the castle strategy with a minimum pulse width of 2.0 ns and recording is envisaged on information layer 1 of the record carrier, it will start reading unit 8 of the control information. The recording device will check the compatibility parameter and notice that it cannot attain the parameter values in set 8. It will subsequently read unit 10, the parameter values of which are compatible with the recording device, and select the parameter values in set 10. The values of the parameters for setting the power and the start times and durations are taken from set 10. The parameters will be used for recording the user information on information layer 1 at 6× speed using the castle write strategy.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for determining the value of a recording parameter for writing user information on an information layer of an optical record carrier using a recording device, the method comprising the steps of:
reading control information from the record carrier relating to a selected write strategy for recording at a specified nominal recording speed on the information layer;
selecting a set of parameter values from a plurality of different sets of parameter values provided in the control information for said write strategy, said recording speed and said information layer; and
taking a value of the recording parameter provided in the selected set of parameter values for recording the user information on the optical record carrier.

2. A method according to claim 1, wherein the set of parameter values is selected from a group of sets of parameter values that are compatible with the recording device.

3. A method according to claim 1 or 2, wherein the sets of parameter values provide recordings on the record carrier having different levels of quality, and the selected set of parameter values provides the highest level of quality of recording on the record carrier.

4. A method according to claim 2, wherein each of the sets of parameter values comprises a value of a compatibility parameter for determining compatibility between the set of parameter values and the recording device.

5. A method according to claim 1 or 4, wherein the sets of parameter values provide recordings on the record carrier having different levels of quality, the sets of parameter values are recorded on the record carrier in order of descending level of quality, and the sets of parameter values are read in order of descending level of quality.

6. An optical record carrier for recording user information on an information layer, comprising a block of control information, the control information comprising information units, a plurality of the information units pertaining to one write strategy for recording at a specified nominal recording speed on the information layer, and each of the plurality of information units comprising a different set of parameter values of one or more parameters pertaining to the write strategy.

7. An optical record carrier according to claim 6, wherein each set of parameter values comprises a value of a compatibility parameter for determining compatibility between the set of parameter values and a recording device for recording user information on the information layer.

8. An optical record carrier according to claim 7, wherein the information units are arranged in the record carrier in the order of descending level of recording quality.

9. An optical recording device comprising a write unit for recording user information on an information layer of an optical record carrier, a read unit for reading information from the record carrier, and a control unit, the operation of the write unit depending on the value of a recording parameter,
wherein the control unit is arranged to control the read unit for reading control information from the record carrier relating to a selected write strategy for recording at a specified nominal recording speed on the information layer, to select a set of parameter values from a plurality of different sets of parameter values provided in the control information for said write strategy, said recording speed and said information layer; and
taking a value of the recording parameter provided in the selected set of parameter values.

10. An optical recording device according to claim 9, wherein the control unit is arranged for selecting a set of parameter values compatible with the recording device.

11. An optical recording device according to claim 9 or 10, wherein the set of parameter values provide recordings on the record carrier having different levels of quality, and the control unit is arranged for selecting the set of parameter values that provides the highest level of quality of recording on the record carrier.
